(19) United States
(12) Patent Application Publication
(10) Pub. No.: US 2009/0150312 A1
(43) Pub. Date: Jun. 11, 2009

(54) Systems And Methods For Analyzing Disparate Treatment In Financial Transactions

(76) Inventors: Clark R. Abrahams, Cary, NC (US); Mingyuan Zhang, Cary, NC (US)

Correspondence Address: Patent Group 2N;Jones Day, North Point, 901 Lakeside Avenue, Cleveland, OH, 44114, US

(21) Appl. No.: 12/368,453

(22) Filed: Feb. 10, 2009

Related U.S. Application Data
(63) Continuation of application No. 11/252,696, filed on Oct. 18, 2005, now abandoned.

(51) Int. Cl. G06F 15/18

(52) U.S. Cl. 706/12

(57) ABSTRACT

Systems and methods are provided for analyzing disparate treatment in financial transactions. Data processing software instructions may be used to process lending-related data to identify a plurality of primary factors and one or more secondary factors for use making a lending-related decision. Model facilitation software instructions may be used to receive one or more relationships between the primary factors and the one or more secondary factors, wherein the relationships define criteria in which one or more positive secondary factors will compensate for a negative primary factor in making the lending-related decision. Model generation software instructions may be used to analyze lending-related data based on the primary factors, secondary factors and the one or more relationships.

### CROSS-REFERENCE TO RELATED APPLICATIONS

This application claims priority from and is related to the following prior application: Systems and Methods for Analyzing Disparate Treatment in Financial Transactions, U.S. Provisional Application No. 60/711,564 filed Aug. 26, 2005. This prior application, including the entire written description and drawing figures, is hereby incorporated into the present application by reference.

This application is a continuation of U.S. patent application Ser. No. 11/252,696, filed on Oct. 18, 2005, and entitled “Systems and Methods for Analyzing Disparate Treatment in Financial Transactions,” the entirety of which is herein incorporated by reference.

### FIELD

The technology described in this patent document relates generally to the field of financial analysis software. More specifically, systems and methods for analyzing disparate treatment and also evaluating creditworthiness in financial transactions are described, which are particularly useful by mortgage lenders, government agencies or other parties to identify potentially disparate treatment in lending-related decisions, such as loan approval credit underwriting, credit pre-approval, credit collection, or others.

### BACKGROUND

The federal government has enacted laws and standards that make discrimination in lending illegal for a variety of protected classes of loan applicants. Key laws are the Fair Housing Act, the Equal Credit Opportunity Act, and the Civil Rights Act of 1866. Enforcement actions and investigations may be conducted by the Department of Justice, bank regulatory agencies (Office of the Comptroller of the Currency, Office of Thrift Supervision, Federal Deposit Insurance Corporation, the Federal Reserve), the Department of Housing and Urban Development, the Federal Trade Commission, and state enforcement agencies.

The methods used to establish lending discrimination vary depending upon the type of discrimination. There are three main categories of discrimination—overt discrimination, disparate treatment, and disparate impact. Overt discrimination occurs when a prohibited factor (e.g. race) is explicitly considered in a negative context in the underwriting process, oftentimes resulting in the denial of credit. Disparate treatment is said to occur when there is evidence that the lender intentionally subjected members of a protected group to “disparate (different) treatment” during the course of the credit transaction. Disparate impact occurs when there is evidence that a lender's policies and practices, although facially neutral, produced discriminatory effects, or had a “disparate impact” on members of a protected class.

To help assure compliance with federal laws, banks and other lending institutions periodically conduct fair lending reviews of their loan underwriting and pricing practices. Over the past thirty years, the methods used to perform these reviews have evolved from manual reviews of physical loan application files associated with minority and non-minority applicants, to the more sophisticated approach of statistically analyzing pertinent information which can be extracted from computer databases. Large lenders, and government regulatory agencies, have adopted the statistical approach because it is more efficient and it allows them to determine whether or not any differences found are statistically significant (i.e., not due to pure chance).

### SUMMARY

Systems and methods are provided for analyzing disparate treatment in financial transactions. As an example, a system and method can include data processing software instructions configured to process lending-related data to identify a plurality of primary factors and one or more secondary factors for use in making a lending-related decision. Model facilitation software instructions may be used to receive one or more relationships between the primary factors and the one or more secondary factors, wherein the relationships define criteria in which one or more positive secondary factors will compensate for a negative primary factor in making the lending-related decision. Model generation software instructions may be used to analyze lending-related data based on the primary factors, secondary factors and the one or more relationships.

### BRIEF DESCRIPTION OF THE DRAWINGS

FIG. 1 is a block diagram depicting example factors that may be considered when making a lending-related decision.

FIGS. 2-5 are block diagrams of example methods for analyzing disparate treatment in financial transactions.

FIG. 6 is a functional block diagram of an example system for analyzing disparate treatment in financial transactions using a dynamic conditional approach.

FIG. 7 is a block diagram of an example data preparation process that may be used in a system for analyzing disparate treatment in financial transactions using a dynamic conditional approach.

FIGS. 8A and 8B are an example of a combined input table.

FIG. 9 is a table illustrating example primary factors.

FIG. 10 is a table illustrating example secondary factors.

FIG. 11 is a table illustrating example protected class variables.

FIG. 12 depicts example flags for treating missing values.

FIG. 13 is an example of a handle matrix in which five analysis variables are used to create a handle variable and a risk category variable.

FIG. 14 is a block diagram of an example model facilitation process that may be used in a system for analyzing disparate treatment in financial transactions using a dynamic conditional approach.

FIG. 15 illustrates example primary factors.

FIG. 16 illustrates example secondary factors.

FIG. 17 is a table illustrating an example of enumerated case scenarios that may be created based on the levels of each primary or secondary factor.

FIG. 18 is a block diagram of an example model development process that may be used in a system for analyzing disparate treatment in financial transactions using a dynamic conditional approach.

FIG. 19 is a block diagram of an example disparate treatment testing process that may be used in a system for analyzing disparate treatment in financial transactions using a dynamic conditional approach.

FIG. 20 depicts an example of estimated parameters for a dynamic conditional regression model.

FIG. 21 depicts an example of estimated odds ratios and 95% confidence intervals for joint race in a dynamic conditional regression model.

FIG. 22 depicts an example plot for changes in deviation vs. predicted probability.

FIG. 23 is a table illustrating estimated parameters.

FIG. 24 is a table illustrating odds ratios after deleting problem covariate patterns.

FIG. 25 is a block diagram of an example reporting module that may be used in a system for analyzing disparate treatment in financial transactions using a dynamic conditional approach.

FIG. 26 is a table illustrating an example matched pair analysis.

FIG. 27 is a table illustrating an example model result report.

FIGS. 28 and 29 are tables illustrating example exception reports.

### DETAILED DESCRIPTION

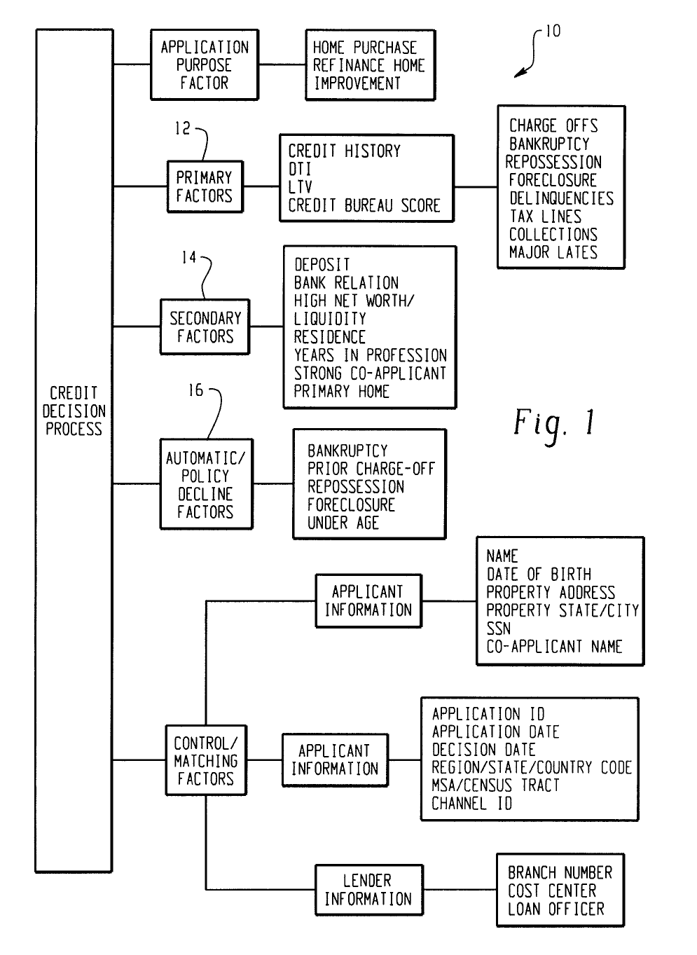

FIG. 1 is a block diagram 10 depicting example factors that may be considered when making a lending-related decision, such as a credit decision. The two main types of factors considered are referred to herein as primary factors 12 and secondary factors 14. Primary factors are those factors which are important to every lending-related decision. Secondary factors are factors that may, in certain instances, be used to compensate for negative primary factors. Examples of primary factors may include credit history, FICO score, loan-to-value (LTV) ratio, debt-to-income (DTI) ratio, or others. Examples of secondary factors may include deposits made by the applicant with the lending institution, the applicant's previous relationship with the lending institution, a high net-worth or liquidity of the applicant, whether the loan is for a primary residence, the number of years in which the applicant has worked in his or her current profession, or others.

FIG. 1 also illustrates that certain factors 16 may often result in the automatic decline of a loan applicant. Automatic-decline factors 16 may include a prior bankruptcy, a prior charge-off, a prior repossession or foreclosure, an under age applicant, or others. Other factors illustrated in FIG. 1 include an application purpose factor that identifies the purpose for the loan or line of credit and control matching factors that identify the applicant and lending institution.

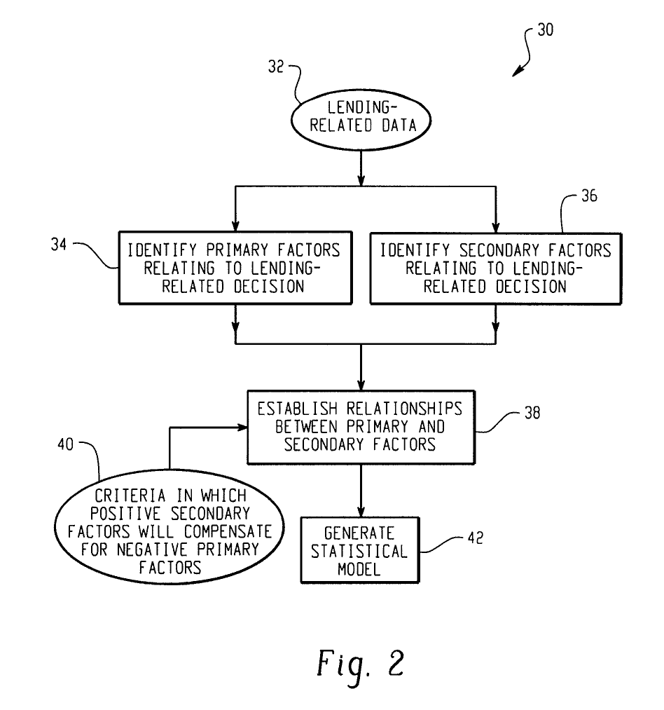

FIG. 2 is a block diagram depicting an example method 30 for analyzing disparate treatment in financial transactions. Lending-related data 32 is processed in steps 34 and 36 to identify a plurality of primary factors and one or more secondary factors that are used in making a lending-related decision. In step 38, one or more relationships between the primary factors and secondary factor(s) are established, with the relationships defining criteria 40 in which one or more positive secondary factors will compensate for a negative primary factor in making the lending-related decision. The primary and secondary factors, along with the defined relationships between the primary and secondary factors, are used in step 42 to generate a statistical computer model for analyzing the lending-related data.

It should be understood that similar to the other processing flows described herein, one or more of the steps and the order in the flowchart may be altered, deleted, modified and/or augmented and still achieve the desired outcome.

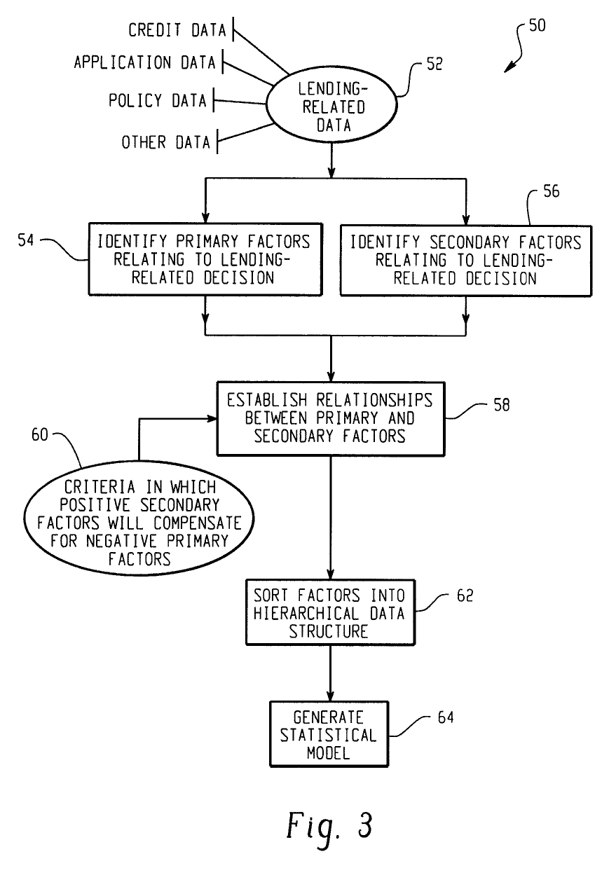

For example, FIGS. 3-5 are block diagrams depicting additional example methods for analyzing disparate treatment in financial transactions. With reference to the example of FIG. 3, lending-related data 52 is processed in steps 54 and 56 to identify a plurality of primary factors and one or more secondary factors that are used in making a lending-related decision. As an illustration, the lending-related data 52 may, for example, include credit data, application data, policy data and/or other data relevant to a financial transaction or loan applicant. In step 58 one or more relationships between the primary factors and secondary factor(s) are established with the relationships defining criteria 60 in which one or more positive secondary factors will compensate for a negative primary factor in making the lending-related decision. The primary and secondary factors are then sorted into a hierarchical data structure in step 62. The hierarchical data structure of primary and secondary factors, along with the defined relationships between the primary and secondary factors, is used in step 64 to generate a statistical computer model for analyzing the lending-related data.

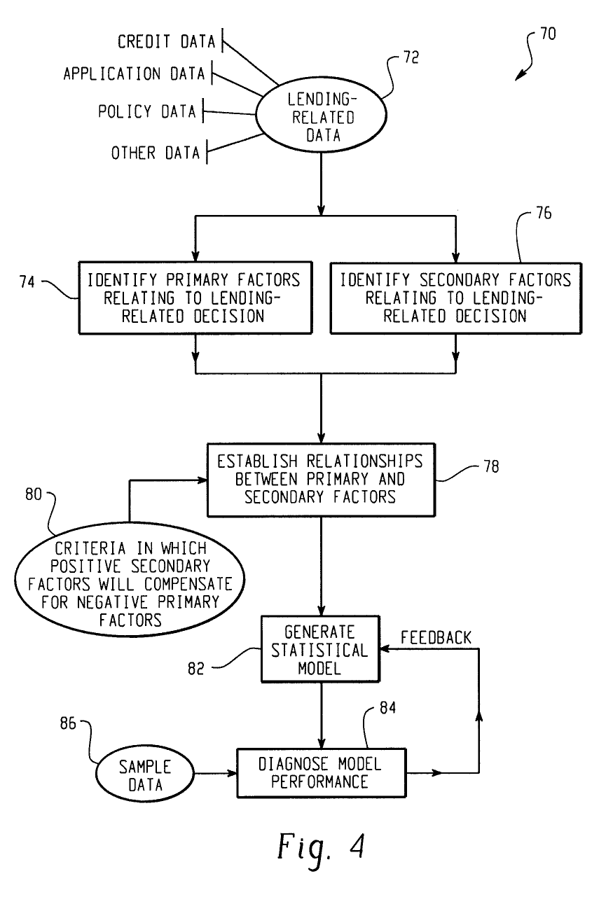

With reference to the example of FIG. 4, lending-related data 72 is processed in steps 74 and 76 to identify a plurality of primary factors and one or more secondary factors that are used in making a lending-related decision. In step 78, one or more relationships between the primary factors and secondary factor(s) are established with the relationships defining criteria 80 in which one or more positive secondary factors will compensate for a negative primary factor in making the lending-related decision. The primary and secondary factors, along with the defined relationships between the primary and secondary factors, are used in step 82 to generate a statistical computer model for analyzing the lending-related data. In step 84, sample data 86 is used to evaluate the performance of the statistical model, and the results may be fed back to step 82 to improve the model's characteristics. For instance, sample data 86, such as a hold-out sample of the lending-related data 72, may be evaluated using the statistical model to generate a sample model output. The sample model output may then be compared with an expected result to evaluate the performance of the statistical model, and the characteristics of the statistical model may be improved based on the comparison.

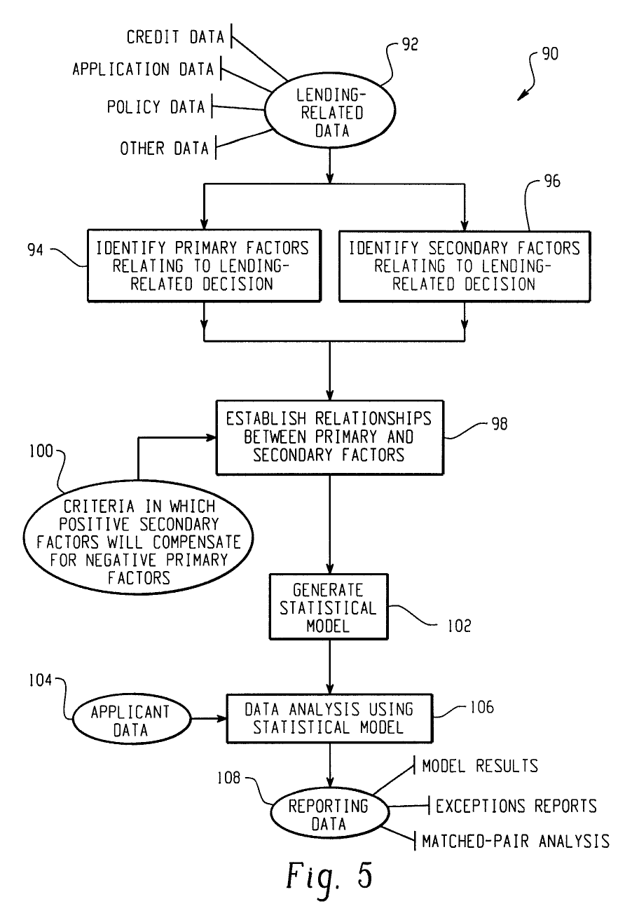

With reference to the example of FIG. 5, lending-related data 92 is processed in steps 94 and 96 to identify a plurality of primary factors and one or more secondary factors that are used in making a lending-related decision. In step 98, one or more relationships between the primary factors and secondary factor(s) are established with the relationships defining criteria 100 in which one or more positive secondary factors will compensate for a negative primary factor in making the lending-related decision. The primary and secondary factors, along with the defined relationships between the primary and secondary factors, are used in step 102 to generate a statistical computer model for analyzing the lending-related data. Loan applicant data 104 may then be analyzed using the statistical model in step 106 to identify disparity between lending-related transactions involving a protected class of loan applicants and lending-related transactions involving a control group of loan applicants. The results from the analysis are reported in step 108. As illustrated, the reporting data 108 may, for example, include statistical analysis results, exceptions reports, a matched-pair analysis and/or other relevant data.

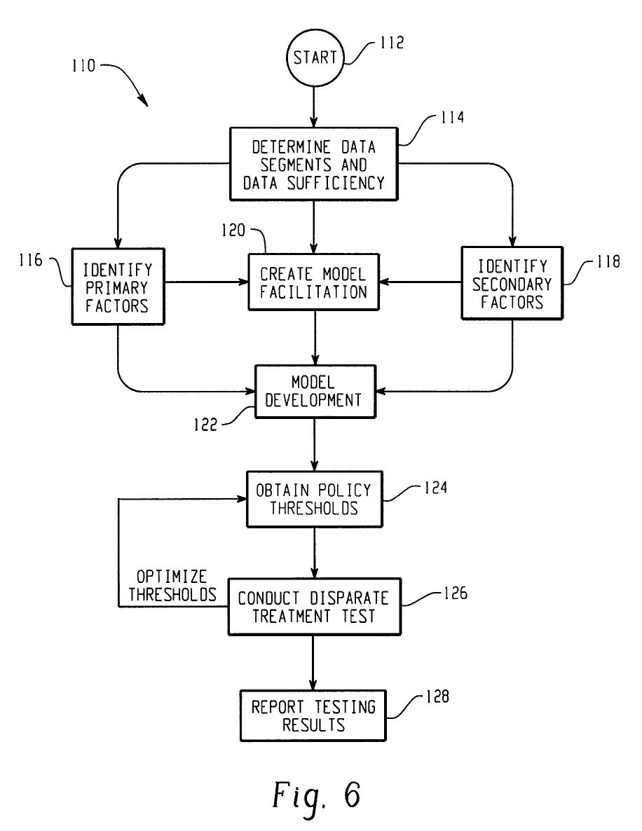

FIG. 6 is a functional block diagram of an example system 110 for analyzing disparate treatment in financial transactions using a dynamic conditional approach. Block 112 illustrates an example starting point for the analysis. The illustrated starting point 112 may, for example, be testing results from a prior data analysis, such as ANOVA (analysis of variance), disparate treatment analysis, etc. In one example, the starting point 112 may continue from the disparate analysis described in commonly-owned U.S. patent application Ser. No. 11/212,289, entitled “Computer-Implemented Lending Analysis Systems and Methods,” which is incorporated herein by reference. The results from preliminary testing may, for example, be used to determine which subsets of data require additional disparate treatment testing. For instance, risk exposure indicators or ANOVA testing may indicate significant origination disparities in some states across a race group, in which case further disparate treatment testing may be needed to analyze disparate treatment associated with loan applicants for certain race groups. A starting point may also be determined by business events such as customer complaints, discovery orders from government enforcement agencies, or lawsuits that pertain to a particular geographic location, time frame, and spanning a particular set of programs and products.

At block 114, lending-related data received by the system 110 is segmented, for instance by segmentation variables such as markets, products, channel, loan type/purpose, etc. For example, data may be subset by state, loan term, product code, program code, loan type, loan purpose, occupancy code, single family dwelling indicator, and/or other criteria. In addition, an initial policy review may be performed, for example to identify broad policy distinctions for underwriting and pricing, to determine the type of decisioning environment (e.g., scoring, manual, automatic rules, etc.), to identify broad program-level differences and relationship/borrower tiers, and/or to identify regional or channel-specific underwriting centers. The lending-related data may also be reviewed in block 114 to determine if sufficient data exists to support segment stratifications. In some cases, data sufficiency can be achieved or the segmentation process can be simplified with dynamic categorizing of primary or secondary factors to reflect the variation in policy thresholds for different products, markets or programs.

At blocks 116 and 118, primary and secondary factors used for making the relevant lending-related decisions are identified. The primary and secondary factors may, for example, be input from a policy data sheet or other financial policy data, but may also be determined by other means.

In block 120, relationships between the primary and secondary factors are identified, and the factors may be sorted into a hierarchical data structure. That is, the model facilitation block 120 determines how secondary factors are nested within primary factors. In one example, this model facilitation function 120 may be performed manually, for instance employing one or more underwriter and/or loan pricing experts. This process may, for example, involve an interactive session to capture critical success factors (e.g., primary factors), compensating factors (e.g. secondary factors), and significant interactions. Conditional structure automatic override rules, and program nuances may also be identified, and the number of distinct segments (e.g., regression models to be developed) may be finalized. In other examples, however, one or more or all of the model facilitation functions may be computer-implemented.

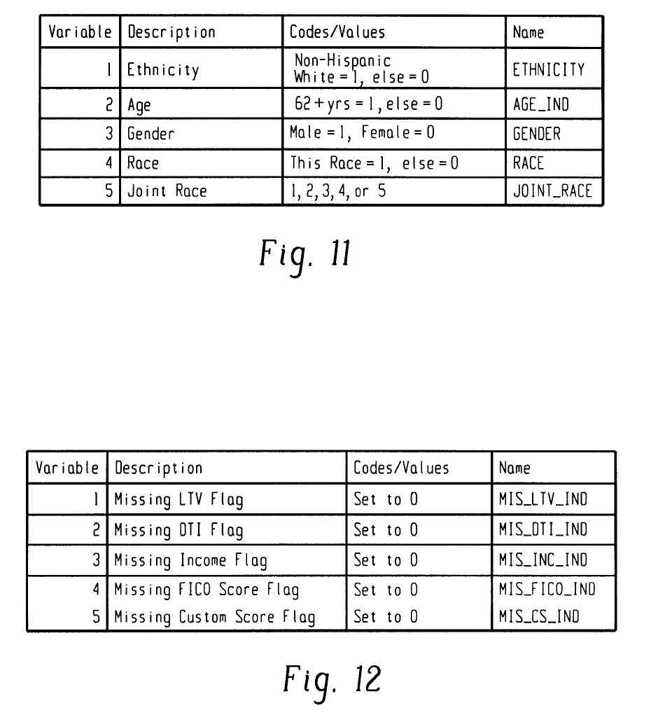

The model facilitation 120 may be based on categorical analysis variables, referred to as handles (see, e.g., FIG. 12), which may be created based on the values of covariates, such as DVI, LTV, or credit score. In this manner, a set of design variables are created that represent the critical values of the covariates, this, in turn, can be used to create hierarchical data structure. The thresholds of these variables may be dynamically determined in block 124, for example based on underwriting policy or statistical attributes of the variables.

In block 122, the primary factors 116, secondary factors 118 and their hierarchical data structure 120 are used to generate one or more statistical models. For example, model facilitation and case scenario data from blocks 116, 118 and 120 may be used, either automatically or manually, to determine specifications of one or more regression models.

In block 126, the statistical model is diagnosed and validated with external data and/or models, such as design trees, other related data mining models, or other data. The validation results may then be used to update or optimize the model specification.

The testing results are then reported to the user in block 128, for example to determine if further analysis is needed.

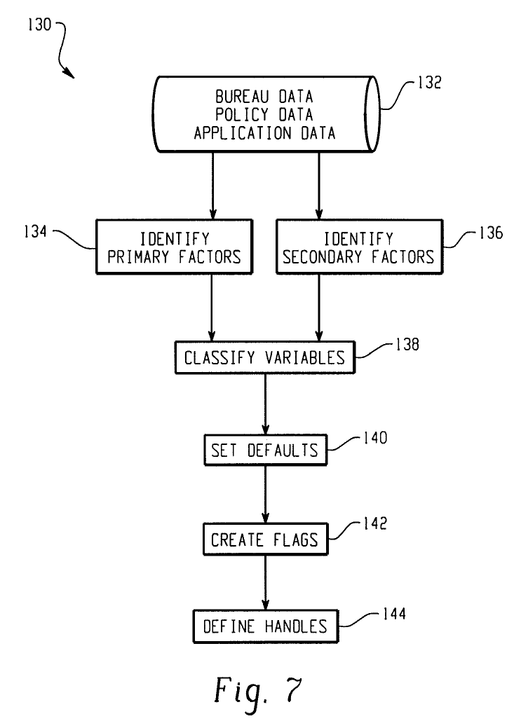

FIG. 7 is a block diagram of an example data preparation process 130 that may be used in a system for analyzing disparate treatment in financial transactions using a dynamic conditional approach. The data preparation process 130 may be a computer-implemented process, a human-implemented process, or may have a combination of human-implemented and computer-implemented steps.

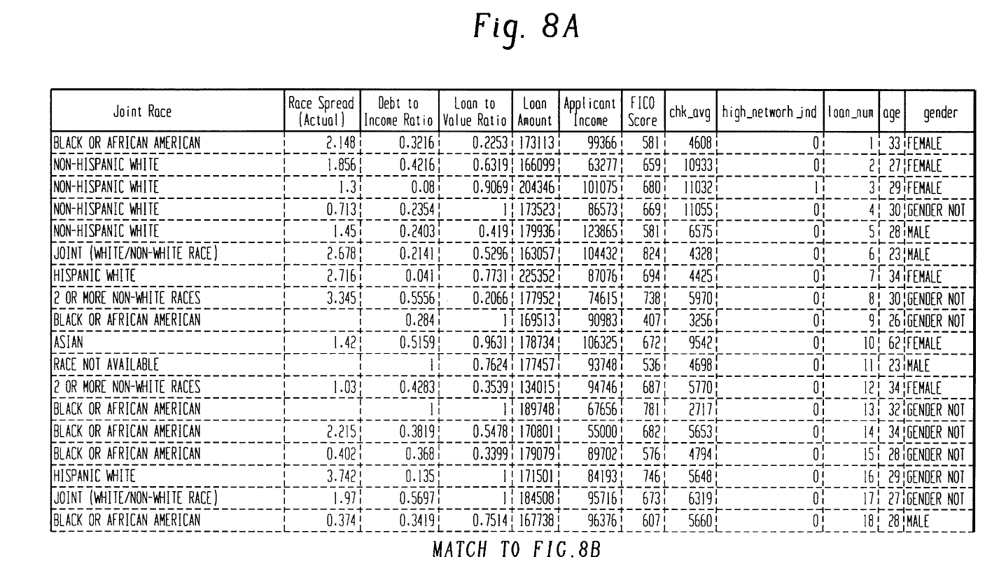

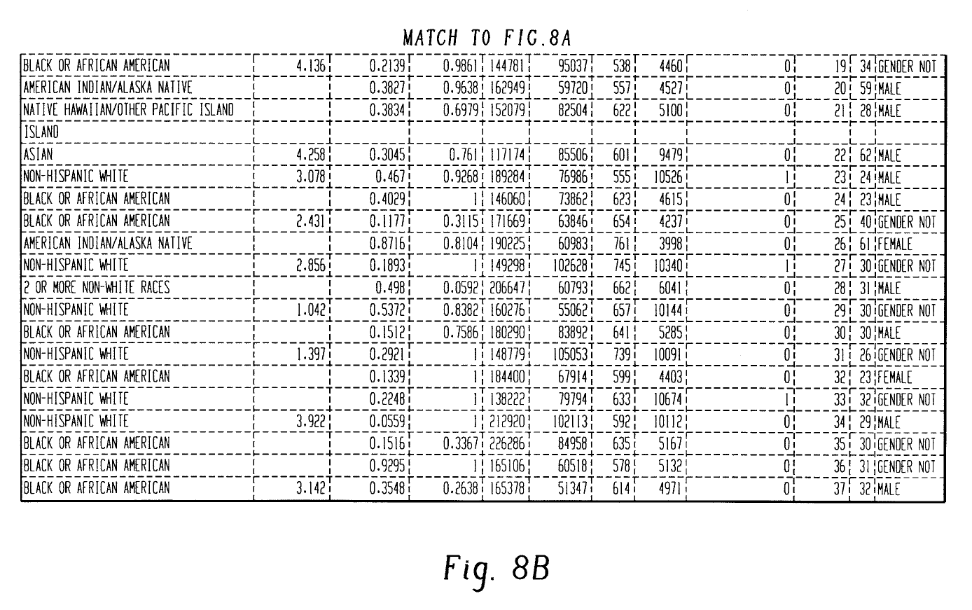

Input data 132 may be derived from a plurality of sources, such as credit bureau data, lending institution policy data, application data, or other lending-related data. Credit bureau data includes data relating to applicants' credit history, such as bank charge offs, bankruptcy, unpaid child support, repossession, foreclosure, current delinquencies, etc. Lending institution policy data may include bank-specific data or policy data, collateral data, etc. Application data may include demographic information relating to loan applicants, such as age, race, ethnicity, income, address, years in a current job, net worth/assets, etc. An example of a combined input table 132 with hypothetical data is illustrated in FIGS. 8A and 8B.

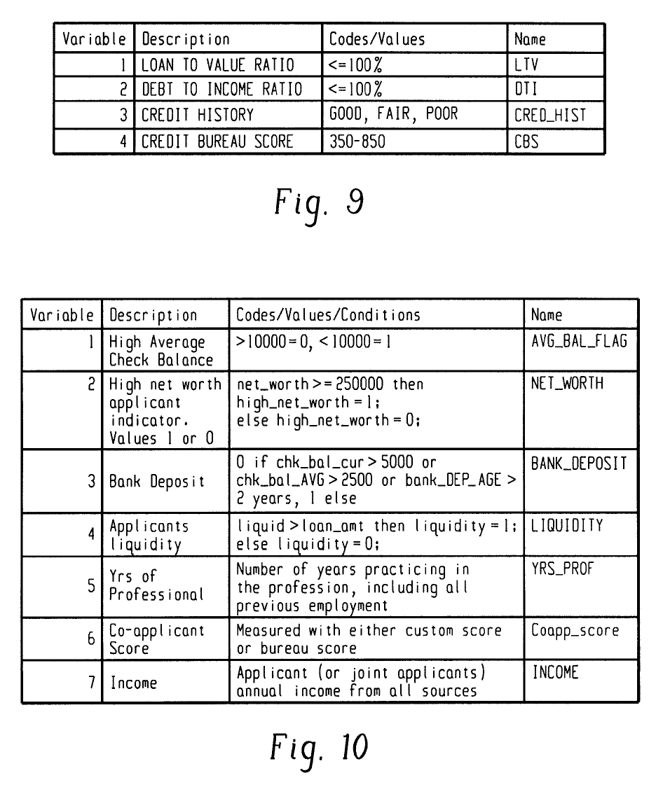

By using the input data 132, primary and secondary factors for making a lending-related decision (e.g., approving or underwriting a loan) are identified in process steps 134 and 136. Primary factors may be factors which are important to all loan decisions. A table illustrating example primary factors is illustrated in FIG. 9. Secondary factors may be factors that can be used to overcome a negative primary factor. A table illustrating example secondary factors is illustrated in FIG. 10. Secondary factors may be identified that correspond to a problem area to be overcome. For example, underwriters may dictate that certain secondary factors may not be used to overcome a recommended loan decline for score, but may be used to overcome a policy exception such as a high DTI.

Examples of primary factors include custom score, FICO score, credit bureau history, loan-to-value ratio (LTV), debt-to-income (DTI) ratio, and/or other factors. A custom score is the score derived from credit scoring models that are specifically designed for a bank. Risk management may determine the appropriate cutoff scores for loan approval based on historic and current performance data and the bank's risk strategy.

An overall credit bureau score is provided by the credit bureaus that pertains to all tradelines for a particular consumer and may be obtained when the application is submitted to the application system. Cutoffs for a passing bureau score can be established based on historic performance data and a bank's risk strategy. In addition, a credit bureau score can be specific to industries, e.g. mortgage, credit card, automobile, or small business.

A credit bureau history normally refers to the credit history of the applicant and can be used to define what constitutes “bad”, or subprime, credit when reviewing a credit file.

A combined LTV ratio is calculated using all lien positions to calculate the total loan amount. Each loan product may have a maximum allowable LTV. Applicants with custom scores that put them in a “high-pass” category may be allowed higher maximum LTVs at the same price point than applicants whose custom scores fall in lower ranges. When calculating LTV for home improving loans, it is necessary to specify the value of the property as being “post-improvement” or “as-is”.

Each loan product may also have a maximum allowable DTI. Applicants with custom scores that put them in a “high-pass” category may be allowed higher maximum DTIs than applicants whose custom scores fall in lower ranges. There are many approaches to calculating the DTI. The credit bureau (CB) debt ratio includes the sum of payments from credit bureau, mortgage debt (listed on the application) and proposed loan payment, divided by gross monthly income.

The following are examples of secondary factors which may be used in some cases to compensate for a negative primary factor:

1. Prior deposit and/or loan relationship with the lending institution—A prior relationship with the lending institution may, for example, be evaluated as a function of its length (e.g., minimum 2 years) and its depth (e.g., average balance above a minimum amount).

2. High net worth and/or high liquidity—The net worth and liquidity of an applicant may be related to assets and liabilities, personal property, life insurance value, IRAs, etc. To qualify as a secondary factor, net worth may be required to be above a predetermined minimum, and liquidity may be required to be sufficient to pay off debt.

3. Years on job or in profession—The applicant's job record may, in certain cases. qualify as a secondary factor. For instance, a number of years on a job over a predetermined minimum may be considered a secondary factor.

4. Low LTV ratio—A low LTV ratio may be considered a secondary factor, for example, if the LTV is a predetermined number of points below a predetermined maximum.

5. Strong co-applicant—A co-applicant meeting certain predetermined criteria may be a secondary factor, for example, if the co-applicant is qualified for the loan, has a good credit history, has a risk score above a predetermined level, has a credit bureau score above a predetermined level, has no late trades, etc.

6. Loan is for a primary residence.

In addition to the primary and secondary factors, other variables may also be identified, such as dependent variables, protected class variables and control variables. Examples of dependent variables may include lending-related decisions, such as approval/denial of loan request, price determination including base rate, fees, and applicable margin, etc. Examples of protected class variables may include ethnicity, age, gender, race, etc., and/or combinations thereof, as illustrated in the table shown in FIG. 11. Control variables may be used to create data segments or similarly-situated loans. Example control variables may include, loan amount, loan term, product code, program code, loan type, loan purpose, occupancy code, single family dwelling indicator, action taken, override reason code, collateral code, etc.

With reference again to FIG. 7, values of the primary and secondary factors, and other variables, are classified in process step 138. The variables may, for example, be classified as either a binary or an ordinal value, depending on the nature of the variable. For example, income data may be classified using binary values (e.g., high or low) and credit history data may be classified using ordinal values (e.g., good, fair or poor).

In process step 140, default values may be assigned to missing values. Default values may, for example, be assigned based on the nature of the data. Examples of flags for treating missing values are illustrated in FIG. 12. In process step 142, one or more flags may be created to trim extreme values or other values that do not provide a good representation of the data.

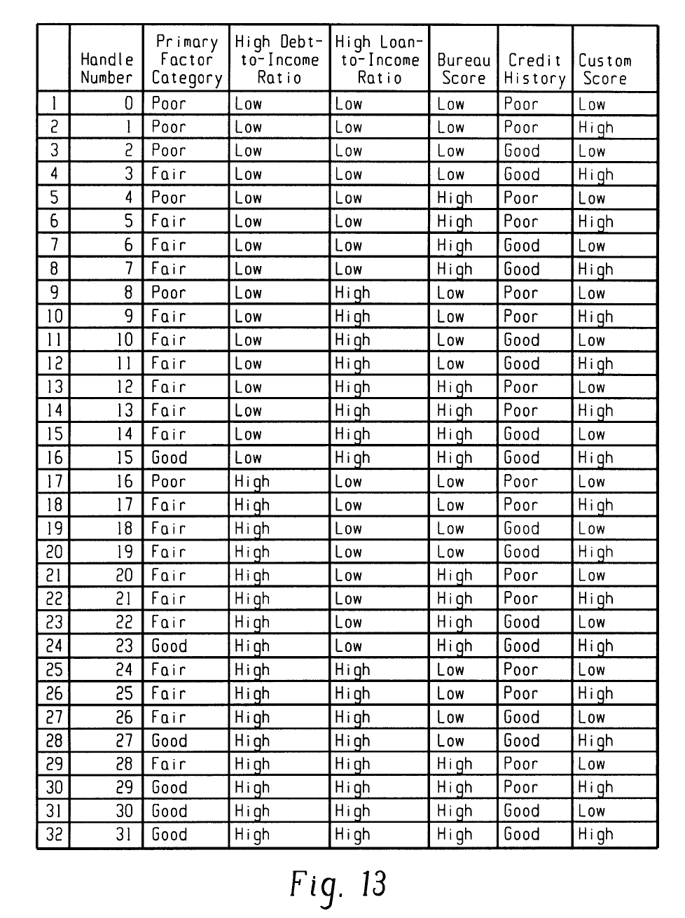

In process step 144, unique combinations of the variables may be created by defining one or more handles. Each handle may be used to represent a unique combination of risk variables (e.g., primary factors) and, therefore, a different degree of risk. In this manner, the handle variable provides a convenient way to combine, organize and analyze a set of risk variables. An example of a handle matrix is depicted in FIG. 13, in which five analysis variables are used to create a handle variable and a risk category variable. The handle variable in FIG. 13 has thirty two unique combinations and represents five different levels of default risk.

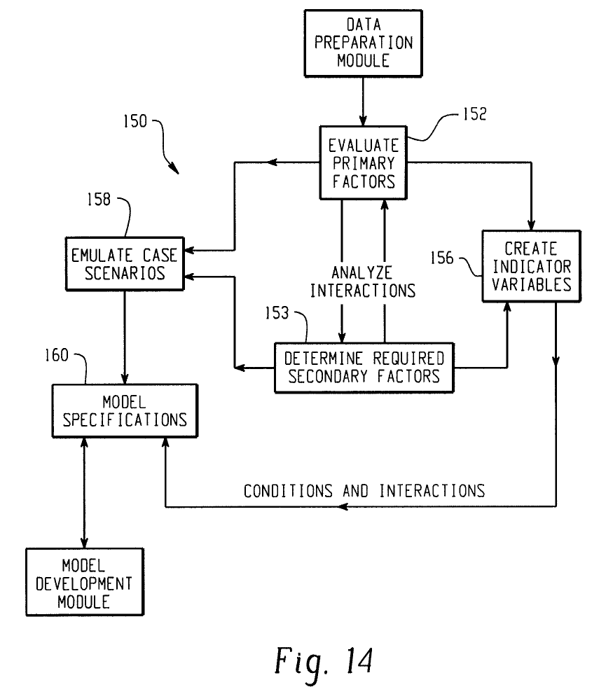

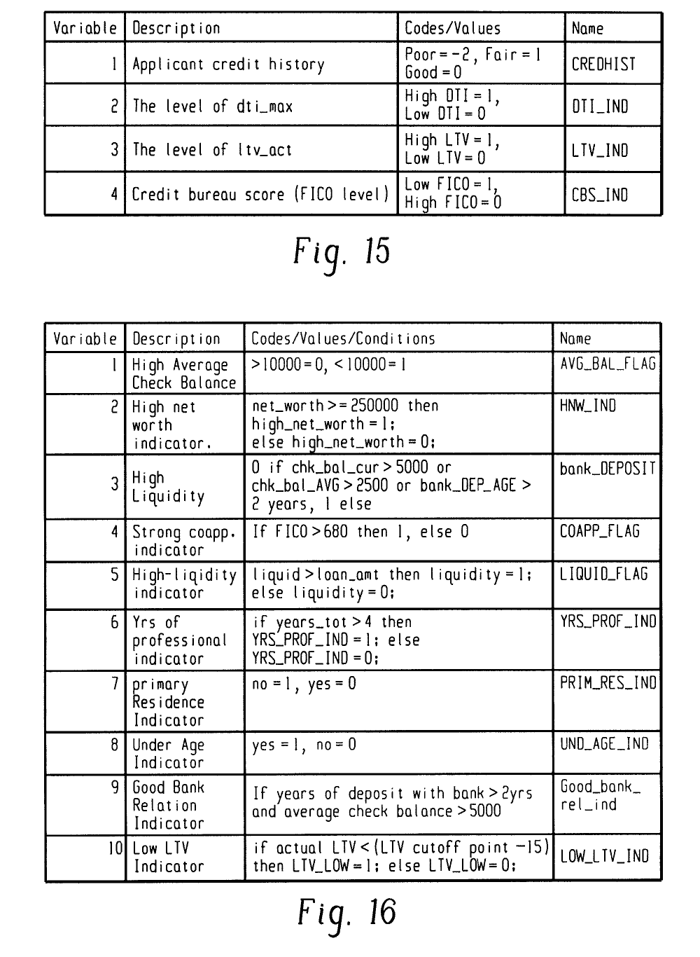

FIG. 14 is a block diagram of an example model facilitation process 150 that may be used in a system for analyzing disparate treatment in financial transactions using a dynamic conditional approach. Lending decision factors are dynamically categorized to capture the variation in policy thresholds by loan products, markets or programs. The model facilitation process 150 may be a computer-implemented process, a human-implemented process, or may have a combination of human-implemented and computer-implemented steps.

The model facilitation process 150 is based upon the fact that the effects of one or more lending factors on loan decision are conditional upon the value(s) of one or more other lending factors. Certain interactions exist between factors, and that some of the applicability of certain secondary factors in making a lending-related decision may depend upon the value of associated primary factors. Secondary factors, for example discretionary income, may only be considered when primary factors are weak. For example, an underwriter may not consider examining discretionary income before making a lending-related decision unless the applicant has a combination of high LTV and low credit score.

Model facilitation may, for example, be conducted using a group of experienced underwriters or other lending experts. However, in other examples a computer-implemented process may also be used, either independently or in conjunction with a model facilitation. During this process, combinations of outcomes associated with the primary factors are enumerated and the appropriate secondary factor-based thresholds (if any) are specified in order to approve the loan or offer the loan at a lower price point.

In process block 152, the primary factors are ranked according to their importance in making the lending-related decision. Example primary factors are illustrated in FIG. 5. In process block 153, one or more secondary factors are identified that may compensate for a negative primary factor. The secondary factors may be nested under the primary factors to form a hierarchical data structure. The primary and secondary factors may, for example, be ranked and nested using handle values created from a set of primary and secondary factors. Example secondary factors are illustrated in FIG. 16.

The primary and secondary factors are analyzed to determine if one or more factors may interact in determining the probability of an applicant being declined or the rate being charged. The primary and secondary factors are also analyzed to determine if the process of underwriting involves the simultaneous consideration of two or more factors in certain situations. For example, the probability of an applicant being approved may depend on the interaction between LTV and credit score. The conditions and interactions between the primary factors and secondary factors are captured using indicator variables in block 156, and the indicator variables are introduced into the model in block 160.

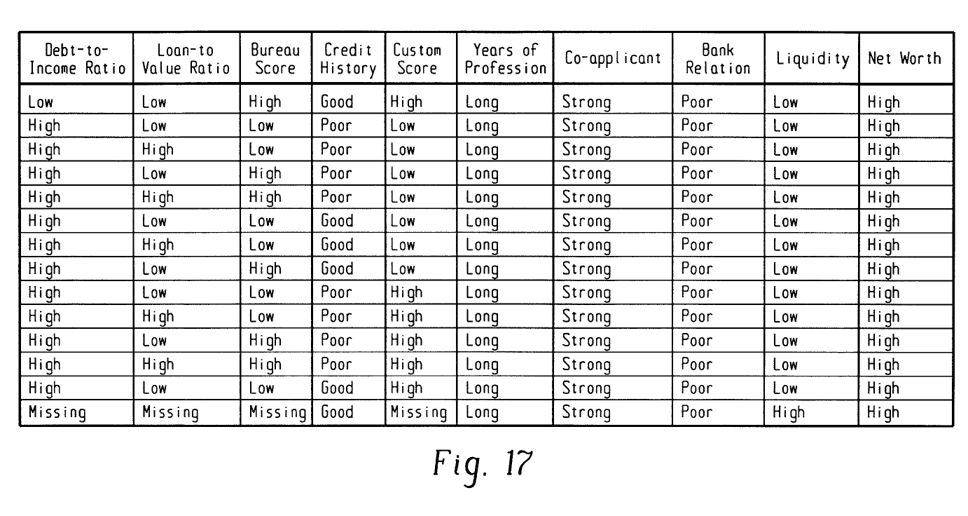

The possible case scenarios are enumerated in block 158 using the primary and secondary factors, and the case scenarios along with the indicator variables are used to create a computer model in block 160. FIG. 17 is a table illustrating an example of enumerated case scenarios that may be created by block 158 based on the levels of each primary or secondary factor. The model facilitation process may then be used to determine how to categorize and simplify the case scenarios and resulting model.

Initially, the model may be fit with all primary factors. Two-way interactions may then be introduced into the model for primary factors in a forward selection stepwise fashion. A p-value criterion may be used to determine whether an interaction should be entered into the model. For example, this may be done for each two-way interaction from a Type 3 analysis produced in Proc GENMOD, which is available from SAS Institute, Inc. The two-way interaction with the smallest p-value less that a predetermined value (e.g., 0.05) may be allowed to enter the model. This process may continue until all interactions are entered into the model, or until the remaining interactions are determined to be ineligible for inclusion in the model.

After the forward selection process is completed, main effects and interactions may be allowed to leave the model in a backward stepwise fashion. Where policy dictates, some variables may be forced to remain in the model regardless of significance, for example primary factors that are required to be weighed in every lending-related decision. A p-value criterion may be used to determine variables leaving the model in a similar fashion to that used in the forward selection process, except that the removal of a term occurs when the p-value is greater than, or equal to, the predetermined value (e.g., 0.05).

The resulting model specifications may be translated into a series of mathematical equations to create the computer model. This may, for example, be accomplished in a SAS data step (using software sold by SAS Institute, Inc. of Cary, N.C.), along with other pre-processing that enables different loan applications to be included in the same model by creating independent policy variables that are general in nature (e.g., high LTV, high DTI, etc.) Based on product and program codes, the appropriate values for any particular loan application may be assigned. For example, a three year Jumbo ARM with a 3% margin cap priced off LIBOR may have a DTI cutoff of 34% and an LTV cutoff of 80%, which a 30 year fixed rate loan in a special homebuyer advantage program may have a DTI cutoff of 40% and an LTV cutoff of 95%. In the first instance, an applicant with a DTI of 36% and a LTV of 90% would have a high LTV and a high DTI, whereas an applicant in the second case with a DTI of 36% and a LTV of 90% would have a low LTV and a low DTI. A SAS data step may, for example, be used to assign the values for all factors for every loan application processed based upon the policy rules associated with all products and programs.

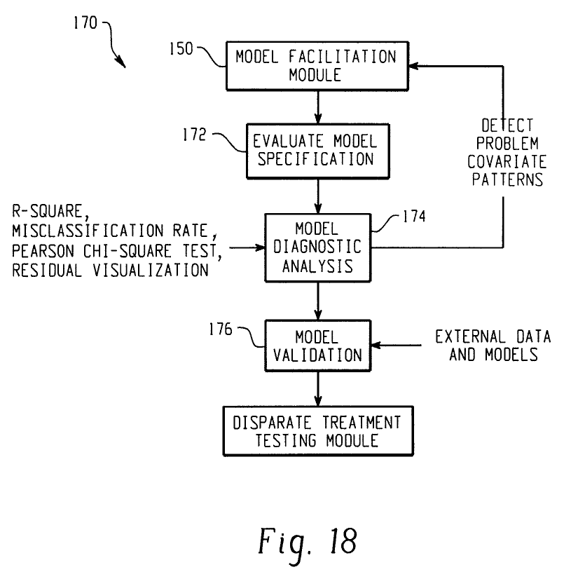

FIG. 18 is a block diagram of an example model development process 170 that may be used in a system for analyzing disparate treatment in financial transactions using a dynamic conditional approach. The model development process 170 may be a computer-implemented process, a human-implemented process, or may have a combination of human-implemented and computer-implemented steps.

Model specification evaluation block 172 receives one or more statistical models from the model facilitation process 150. Block 172 may be required when 1) models specified in block 150 need further refinement, or 2) block 150 is not utilized and the models must be developed based largely on data analysis. Multi-collinearity diagnostics are performed and correlation matrices are examined, along with variance inflation factors, condition indices and variance decomposition proportions to assess possible model specification issues.

After the model specification have been formulated and executed, the model fit is evaluated in the model diagnostic analysis block 174. Diagnostics used to evaluate model fit may include R-square, misclassification rate, a Pearson Chi-Square test, residual visualization, etc. In an R-square evaluation, the log likelihood-based R square in the model building stage is used for comparing two competing models. Although low R-square values in logistic regression are common and routine reporting of R-square is not recommended, it may still be helpful to use this statistic to evaluate competing models which are developed with the same data sets. A misclassification rate may be derived from a classification table based on the logistic regression models. The Pearson chi-square statistics may be evaluated to test for model goodness-of-fit measures. In general, a higher p-value and/or a smaller Pearson chi-square statistic indicates a better goodness-of-fit for a particular model specification.

The stability of the protected class (e.g., minority) parameter estimate may be of particular concern in diagnosing a model because the effect of the protected class variable on the probability of decline is what the regression analysis is attempting to determine. Scatter plots may be used to examine the regression diagnostics. Scatter plots used for model diagnosis may include a bubble plot showing the change in deviation from deleting some covariate patterns versus the estimated probability of decline, where the size of the bubble represents the standardized change in parameter estimates. Another example bubble plot may show the change in Pearson chi-square from deleting some covariate patterns versus the estimated probability of decline, where the size of the bubble represents the standardized change in parameter estimates. Another example plot may show the change in certain parameter estimates from deleting some covariate patterns versus the estimated probability of decline.

In process block 176, the fitted model is validated with external data (e.g., a holdout sample) and compared against competing models. This process may, for example, be performed using SAS Enterprise Miner software sold by SAS Institute Inc. of Cary, N.C. The data is split into two subsets, learning data and holdout samples. The learning dataset is used to develop the models to test various hypotheses. The learning dataset may also be used to develop a series of competing models. In the latter case, the holdout sample may be used to select the best model from a set of candidate models. In addition, the model validation process 176 may also be performed by scoring an external data set with the selected model. Finally, it should be noted that re-sampling techniques may be applied as needed in the validation process.

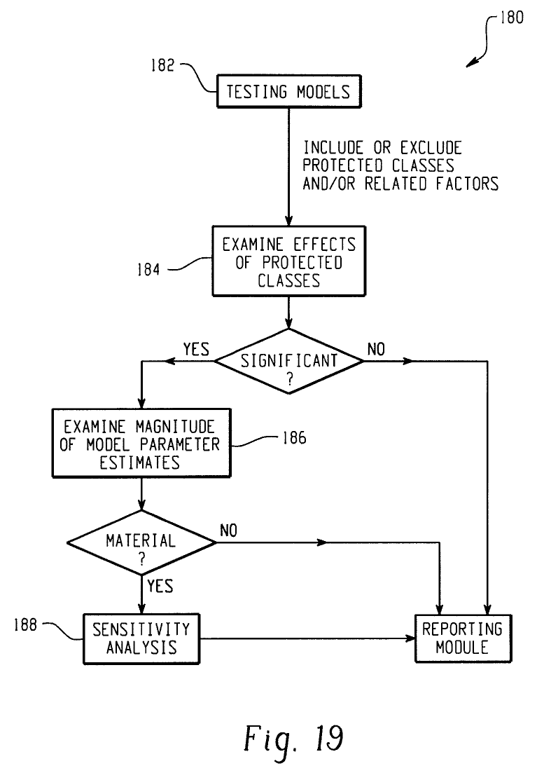

FIG. 19 is a block diagram of an example disparate treatment testing process 180 that may be used in a system for analyzing disparate treatment in financial transactions using a dynamic conditional approach. The disparate treatment testing process 180 uses a developed regression model to examine the effects of the protected classes or related terms on loan decline. The disparate treatment testing process 180 may be a computer-implemented process, a human-implemented process, or may have a combination of human-implemented and computer-implemented steps.

In block 182, one or more models are executed to analyze lending-related data for disparate treatment. The effects of protected classes on lending-related decisions may then be examined in block 184. The inferential goals of a disparate treatment testing may, for example, be examined by analyzing model coefficient estimates and their significance level. This may involve the interpretation and presentation of model coefficients, standard error, Wald chi-square statistics, a related p-value, odds ratios, or other data.

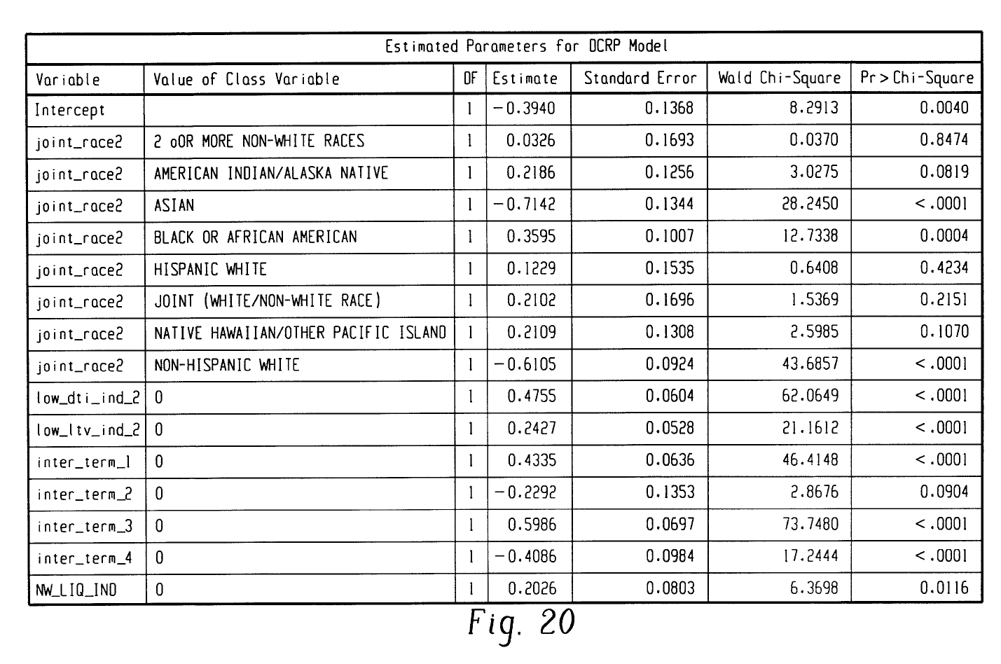

For models that show a significant impact from protected variables, the materiality of the variables is examined in block 186 by examining the signs of the model parameter estimates. For example, variables having a negative value may indicate a negative impact on the probability of decline, while variables having a positive value may indicate a positive impact on the probability of decline. FIG. 20 depicts an example of estimated parameters for a dynamic conditional regression model. In the example of FIG. 20, all coefficients for the race design variables, except for “2 or More Non-White Races” and “Joint (White/Non-White Race)” are significant at a 10% significance level. In particular, the signs for Asian and non-Hispanic White are negative, indicating a negative impact on the probability of decline. The signs for other races are all positive and indicate a positive impact on the probability of decline.

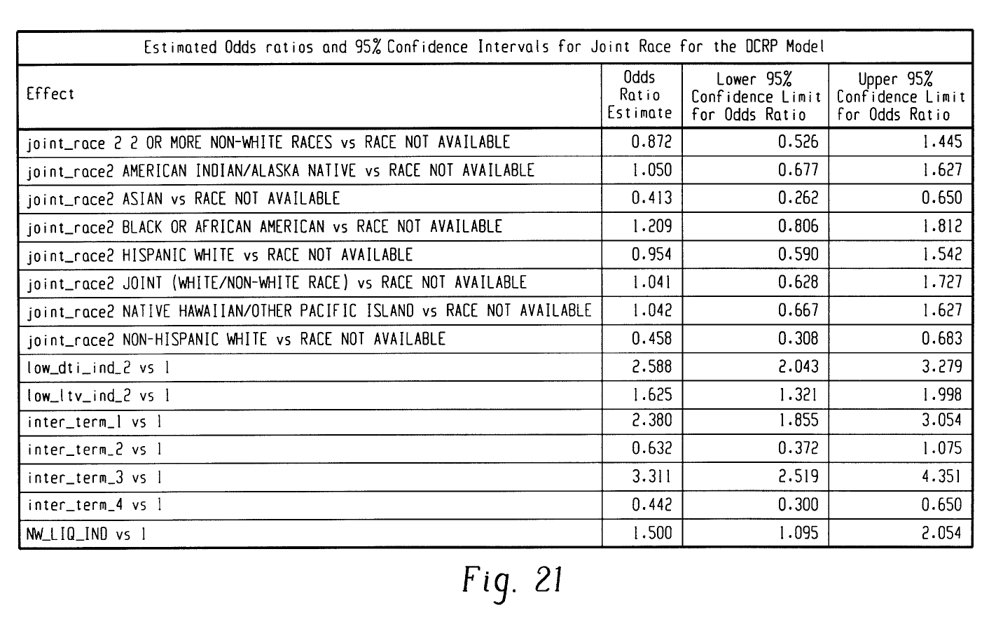

In addition, the odds ratio across all classes of the protected variable(s) may be compared to further evaluate materiality. FIG. 21 depicts an example of estimated odds ratios and 95% confidence intervals for joint race in a dynamic conditional regression model. For example, the illustrated odds ratio for Black or African American in the example of FIG. 21 is 1.302, while the odds ratio for Non-Hispanic White is 0.475, indicating that Black or African American applicants are about 2.7 (1.302/0.475) times more likely to be declined compared with Non-Hispanic White applicants.

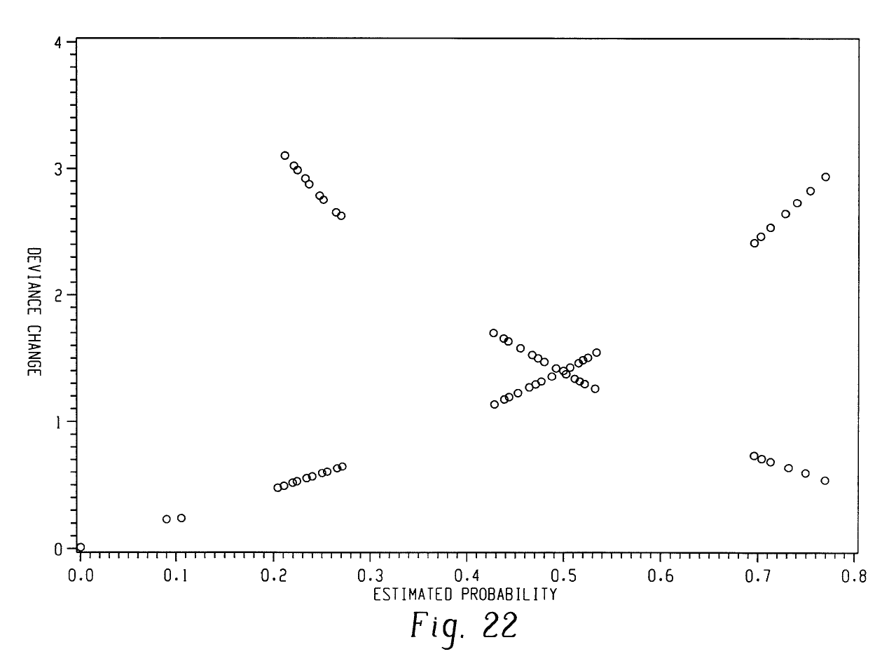

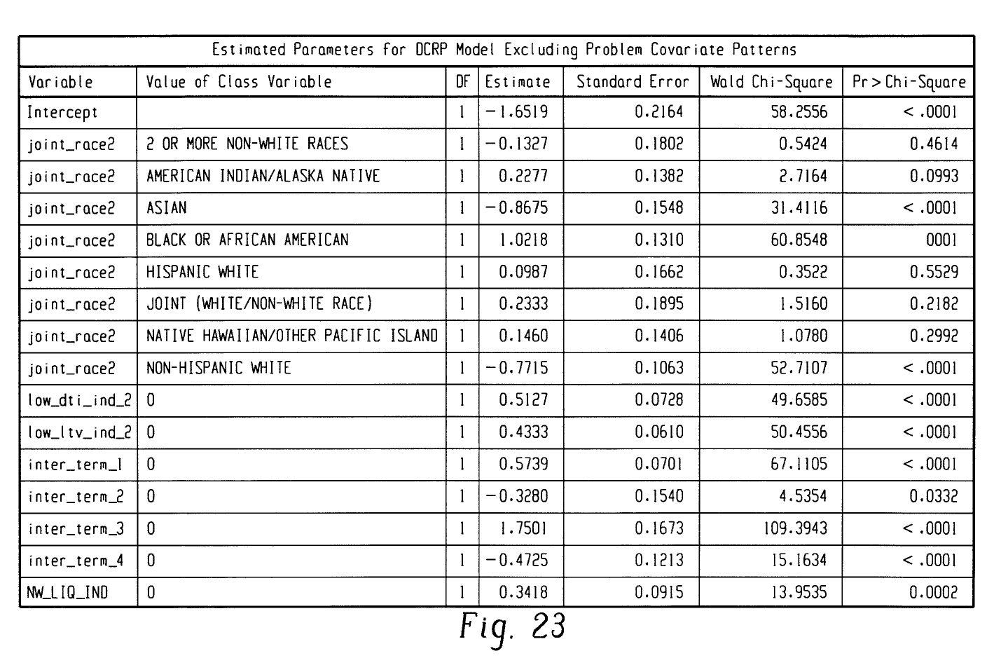

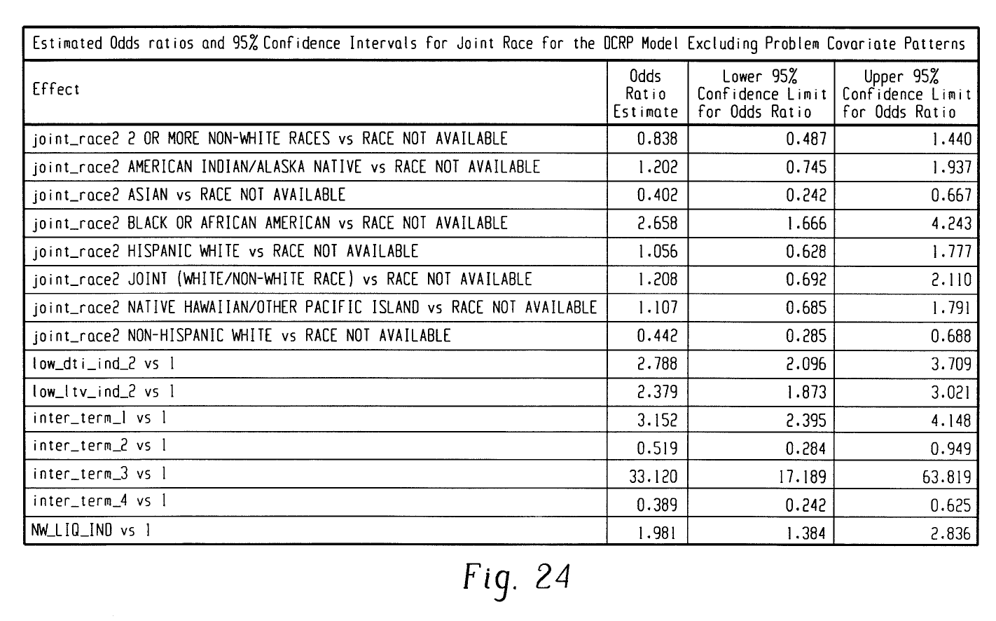

With reference again to FIG. 19, a sensitivity analysis may be performed in block 188 to further validate the model results to help reduce false positive or false negative error. In this process 188, the signs or magnitudes of estimated coefficients for protected classes are examined to determine how they are influenced by some deficiency or extreme covariate patterns included in the model. The sensitivity analysis may be based on regression diagnostics. Models that are less sensitive to the inclusion/exclusion of some extreme data are more robust and the results of disparate treatment can be more pronounced. FIG. 22 depicts an example plot for changes in deviation, which measures the model fit, or variation between the fitted and observed values, vs. predicted probability, FIG. 23 is a table illustrating the estimated parameters, and FIG. 24 is a table illustrating odds ratios after deleting some problem covariate patterns. After deleting some problem covariate patterns from the data, for example, the estimated model parameters are improved slightly and all signs still remain the same and significant.

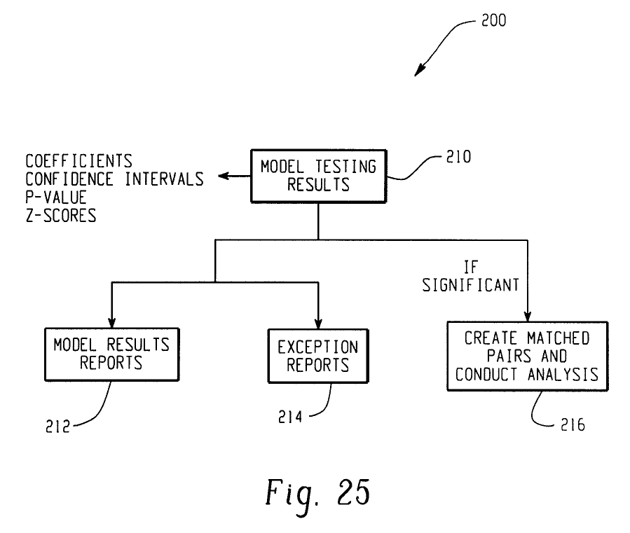

FIG. 25 is a block diagram of an example reporting module 200 that may be used in a system for analyzing disparate treatment in financial transactions using a dynamic conditional approach. Model testing results 210 (coefficients, confidence intervals, P-value, Z-scores, etc.) are received, for example from a disparate treatment testing module 180, and are used by the reporting module 200 to generate one or more reports. As illustrated, the reports may include model results reports 212, exception reports 214 and/or a matched pair and conduct analysis 216.

Results from a dynamic conditional regression model may be used to construct matched pairs post regression for reporting exceptions. With the estimated probability of denial, or estimated probability of high cost loan, or estimated rate spread for each loan applicant, the matched pairing process may be used to sort the observations by who is most likely to be denied, to be given a high cost loan, or to be charged the most as reflected in the rate spread. Matched pair files usually contain minority declines matched to both minority and non-minority approvals. The matched pairs may be constructed by first matching minority declines to non-minority approvals using certain criteria.

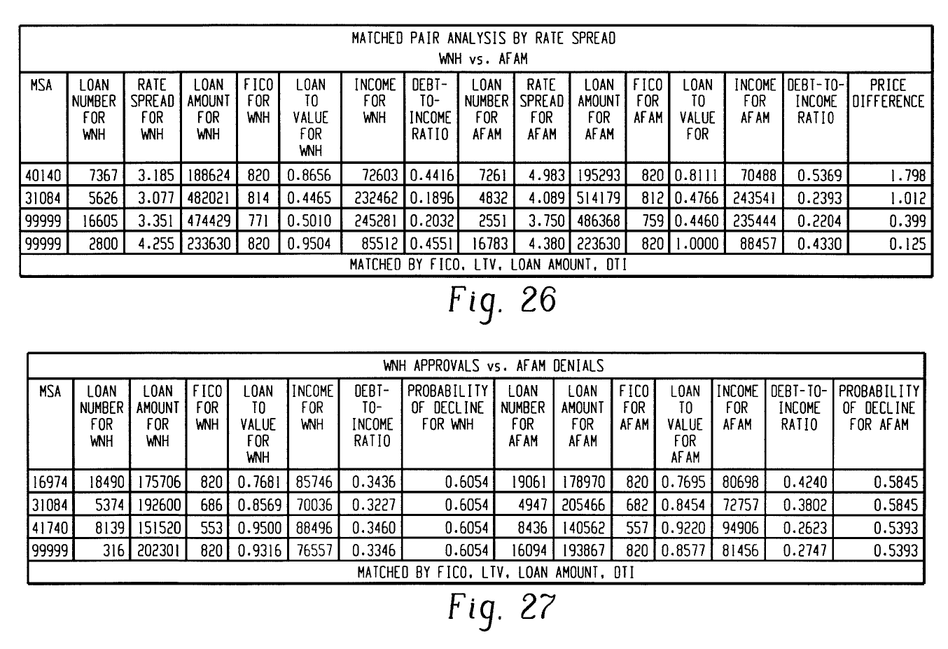

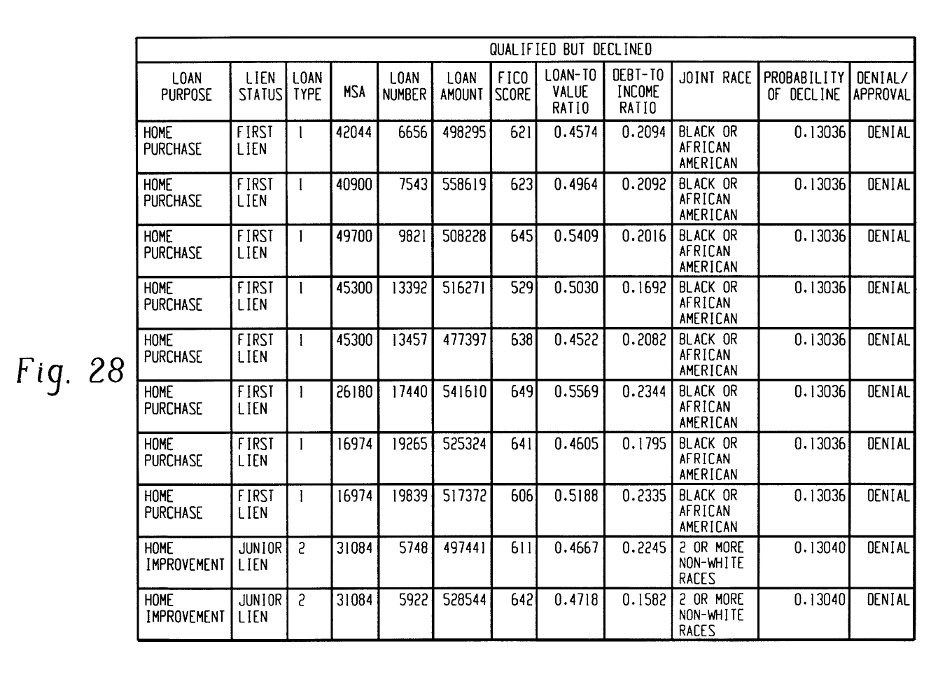

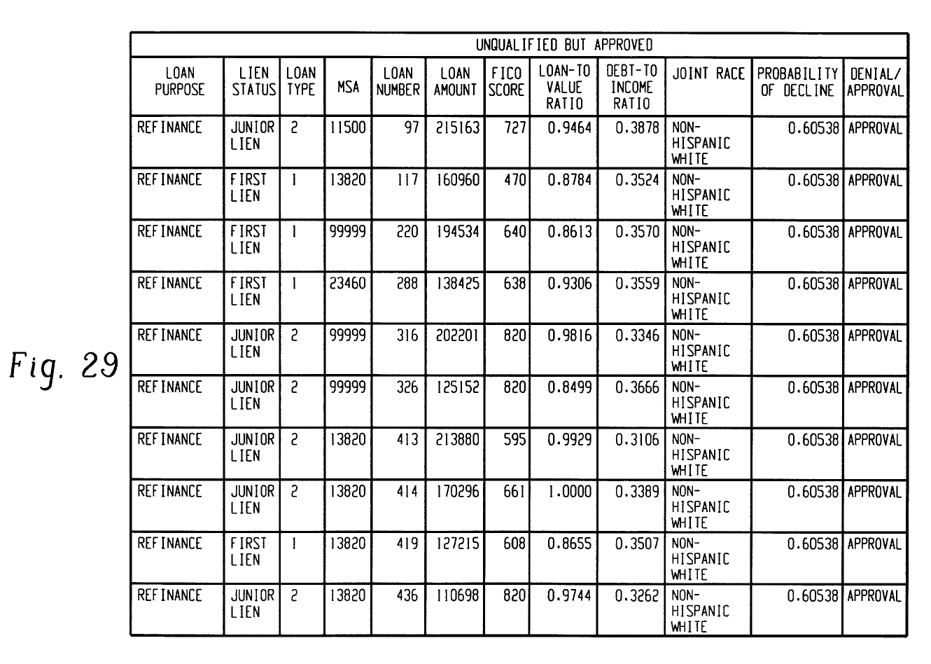

An example matched pair analysis 216 is illustrated in FIG. 26, an example model result report 212 is illustrated in FIG. 27, and an example exception reports 214 are illustrated in FIGS. 28 and 29. More specifically, the example report depicted in FIG. 26 illustrates hypothetical matched pairs for white non-Hispanic applicants vs. African American applicants. FIG. 27 illustrates an example report including hypothetical white non-Hispanic applicant approvals vs. African American denials. FIG. 28 illustrates an example exception report illustrating hypothetical qualified but declines applicants. FIG. 29 illustrates an example exception report illustrating hypothetical unqualified but approved applicants.

This written description uses examples to disclose the invention, including the best mode, and also to enable a person skilled in the art to make and use the invention. The patentable scope of the invention may include other examples that occur to those skilled in the art.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A system, comprising:
a computer readable medium comprising data;
a computer;
data processing software instructions stored on the computer readable medium and executable by the computer, the data processing software instructions being configured to receive a plurality of primary variables and one or more secondary variables, wherein a primary variable is used to determine every outcome, and wherein one or more secondary variables are used with a primary variable to determine a particular outcome;
the data processing software instructions further configured to receive one or more relationships between the plurality of primary variables and the one or more secondary variables, the one or more relationships identifying combinations of a primary variable and one or more secondary variables that can be used to determine a particular outcome;
model generation software instructions stored on the computer readable medium and executable by the computer, the model generation software instructions being configured to generate a statistical model for use in analyzing data, wherein the statistical model is generated using the plurality of primary variables, the one or more secondary variables and the one or more relationships between the plurality of primary variables and the one or more secondary variables; and
data analysis software instructions stored on the computer readable medium and configured to analyze the data using the statistical model to identify disparities between particular outcomes.

2. The system of claim 1, further comprising:
diagnostic software instructions stored on the computer readable medium and configured to evaluate sample data using the statistical model to generate a sample model outcome;
model evaluation software instructions stored on the computer readable medium and configured to compare the sample model outcome with an expected outcome to evaluate the statistical model's performance; and
model optimization software instructions stored on the computer readable medium and configured to alter characteristics of the statistical model based on the comparison of the sample model outcome with the expected outcome.

3. The system of claim 1, wherein the statistical model is a regression model.

4. The system of claim 1, wherein the particular outcome is whether or not to approve a loan.

5. The system of claim 1, wherein the particular outcome is whether or not to price a loan above a given threshold.

6. The system of claim 1, wherein the particular outcome is whether or not to steer a loan applicant to a given sub-prime product.

7. The system of claim 1, wherein the particular outcome is whether or not to solicit an individual for a particular mortgage loan product or program.

8. The system of claim 1, wherein the particular outcome is how much to charge a loan applicant for a product based upon factors related to borrower risk, channel, collateral, market condition, product features, and terms of transaction.

9. The system of claim 1, wherein one or more of the primary variables or secondary variables are defined using a handle that represents a combination of variables.

10. The system of claim 1, further comprising:
model reporting software instructions configured to generate one or more reports that display reporting data relating to the data.

11. The system of claim 1, wherein the data analysis software instructions are further configured to calculate the materiality of protected class variables.

12. A computer-implemented method, comprising:
receiving data;
receiving a plurality of primary variables and one or more secondary variables, wherein a primary variable is used to determine every outcome, and wherein one or more secondary variables are used with a primary variable to determine a particular outcome;
receiving one or more relationships between the plurality of primary variables and the one or more secondary variables, the one or more relationships identifying combinations of a primary variable and one or more secondary variables that can be used to determine a particular outcome;
generating a statistical model based upon the primary variables, the one or more secondary variables, and the one or more relationships and storing the generated statistical model in a computer readable medium;
analyzing the data using the statistical model to identify disparities between particular outcomes.

13. The method of claim 12, further comprising:
evaluating sample data using the statistical model to generate a sample model output;
comparing the sample model output with an expected result to evaluate the statistical model's performance; and
altering characteristics of the statistical model based on the comparison of the sample model output with the expected result.

14. The method of claim 12, wherein each secondary variable is nested under at least one primary variable in a hierarchical data structure.

15. The method of claim 12, wherein the statistical model is a regression model.

16. The method of claim 12, wherein the particular outcome is whether or not to approve a loan.

17. The method of claim 12, wherein the particular outcome is whether or not to price a loan above a given threshold.

18. The method of claim 12, wherein the particular outcome is whether or not to offer a given sub-prime product to a loan applicant.

19. The method of claim 12, wherein the particular outcome is whether or not to solicit an individual for a particular mortgage loan product or program.

20. The method of claim 12, wherein the particular outcome is how much to charge a loan applicant for a product based upon factors related to borrower risk, channel, collateral, market condition, product features, and terms of transaction.

21. The method of claim 12, further comprising:
generating one or more reports that display report data relating to the analysis of the data.

22. The method of claim 12, wherein one or more of the primary variables or secondary variables are defined using a handle that represents a combination of variables.

23. A computer-readable medium storing software instructions that when executed by a computer implement a method comprising:
receiving data;
receiving a plurality of primary variables and one or more secondary variables, wherein a primary variable is used to determine every outcome, and wherein one or more secondary variables are used with a primary variable to determine a particular outcome;
receiving one or more relationships between the plurality of primary variables and the one or more secondary variables, the one or more relationships identifying combinations of a primary variable and one or more secondary variables that can be used to determine a particular outcome;
generating a statistical model based upon the primary variables, the one or more secondary variables, and the one or more relationships and storing the generated statistical model in a computer readable medium;
analyzing the data using the statistical model to identify disparities between particular outcomes.
